(19) United States
(12) Patent Application Publication
(10) Pub. No.: US 2008/0060711 A1
(43) Pub. Date: Mar. 13, 2008

(54) Hydraulic Accumulator

(76) Inventor: Armin Kort, Riegelsberg (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/661,403

(22) PCT Filed: Jun. 8, 2005
(86) PCT No.: PCT/EP05/06137

§ 371 Date: Feb. 28, 2007

(30) Foreign Application Priority Data
Sep. 8, 2004 (DE) 10 2004 043 352.6

(51) Int. Cl. F15B 1/04

(52) U.S. Cl. 138/31; 60/413

(57) ABSTRACT

The invention relates to a hydraulic accumulator, especially a piston accumulator, comprising an accumulator housing (10) and a separating piston that can be longitudinally displaced in the accumulator housing (10) and divides two working chambers (12) inside the accumulator housing (10). The housing is sealed on each end by respectively one cover part (16). At least one cover part is fixed; on one side (32) thereof, by means of a free longitudinal edge (34) of the accumulator housing (10), said edge being arranged against the cover part (16). By connecting the free longitudinal edge (34) of the accumulator housing (10) to the associated cover part (16) by means of a peripheral weld seam (46) for sealing at least one working chamber (12) from the environment in a gas-tight and/or fluid-tight manner, a reliable sealing is obtained by the weld seam (46), said weld seam also connecting the free longitudinal edge (34) of the accumulator housing (10) to the associated cover pant (16).

The invention relates to a hydraulic accumulator, in particular a piston accumulator, having an accumulator housing, and a separator piston which can be moved in the longitudinal direction in the accumulator housing and which separates two working chambers from one another within the accumulator housing which is closed on each end side by a respective cover part, at least one cover part on its one side being fixed by way of one free longitudinal edge of the accumulator housing, which is advanced onto this cover part for this purpose.

Piston accumulators are in the broadest sense so-called hydraulic accumulators which are used among other things to hold certain volumes of a pressurized liquid (hydraulic medium) of a hydraulic system and to return it if necessary to the system. Since the hydraulic medium is under pressure, hydraulic accumulators are treated like pressure vessels and must be designed for the maximum operating overpressure with consideration of the acceptance standards of diverse delivery countries. In most hydraulic systems at present hydropneumatic (gas-pressurized) accumulators with separating elements are used, for piston accumulators the separating element being a piston which within the piston accumulator housing separates a liquid chamber as the working chamber from the gas chamber as another working chamber. The working gas is generally nitrogen and the gas-tight piston largely permits decoupling from the gas chamber to the liquid chamber.

The liquid part is connected to the hydraulic circuit of the system so that when the pressure rises the piston accumulator holds the hydraulic medium and the gas is compressed. When the pressure drops, the compressed gas expands and displaces the stored pressurized liquid back into the hydraulic circuit of the system. One advantage of a piston accumulator is that it can “work” in any position, but a vertical configuration with the gas side up is preferred so that settling of dirt particles from the liquid on the seals of the piston part is avoided.

The important components of a piston accumulator are accordingly an external cylinder pipe as the accumulator housing, the piston as the separating element with its sealing system and the end-side sealing cover which as cover parts at the same time also contain a liquid and gas port. Generally the accumulator housing has two functions, specifically on the one hand storing the internal pressure and on the other guiding the piston within the accumulator housing. The cover parts which blank off the interior of the accumulator housing relative to the exterior on the end side are provided with an external thread on the outer peripheral side which can be screwed into a corresponding internal thread along the free longitudinal edge of the accumulator housing over a definable distance. Producing this threaded connection is time-consuming; this makes the production costs for a piston accumulator accordingly higher. Furthermore safety measures must be taken to lock the added cover part in its position in the accumulator housing.

Conversely, DE 103 03 988 A1 has already proposed, avoiding the otherwise conventional threaded connections, ensuring a reliable and secure connection of the cover part in the housing of the piston accumulator. For this purpose, in the indicated generic solution on one side of the cover part it is fixed over the free longitudinal edge of the accumulator housing which for this purpose undergoes a feed motion onto the cover part during the production process of the hydraulic accumulator, so that while avoiding the otherwise conventional screw connection solution for the respective cover part a type of clamp seat on the respective free end of the accumulator housing is achieved, in which the cover part is clamped fast at least over the free longitudinal edge of the accumulator housing after its feed motion during production onto the cover part. In this connection it is sufficient if part of the free longitudinal edge implements this clamping seat.

Although for the indicated hydraulic accumulator solution the respective cover part is provided with sealing means, especially in the form of gaskets, it cannot be precluded that especially at high pressures in the working chambers and/or for correspondingly long service lives the medium stored in the working chamber unintentionally travels to the exterior. Especially when using a working gas for the working chamber of the accumulator it must be expected that portions of gas will travel to the exterior via the sealing means of the cover part; viewed over the long-term, this degrades the operating reliability of the hydraulic accumulator. The latter occurs especially when the hydraulic accumulator with its sealing means is exposed to major temperature fluctuations which are of the magnitude of −40° C. to 130° C.; this is a range of values in which the elastomer material of the sealing means generally yields.

In the known hydraulic accumulator solutions there is generally the possibility of adding working gas to the pertinent working chamber of the accumulator; this however is accompanied by the corresponding maintenance cost which is especially undesirable if the designed hydraulic accumulators are to be used in the form of a disposable solution on site within the hydraulic system only for a predetermined time. For the correspondingly designed hydraulic accumulator and depending on its application, it can be more economical to replace it terms of a disposable solution by a new one rather than maintain it on site.

On the basis of this prior art, the object of the invention is to further improve the described hydraulic accumulator solutions such that they are largely media-tight on their gas side so that they can also be designed as so-called disposables. This object is achieved by a hydraulic accumulator with the features of claim 1 in its entirety.

In that, as specified in the characterizing part of claim 1, for gas-tight and/or fluid-tight sealing of at least one working chamber relative to the exterior the associatable, advanced free longitudinal edge of the accumulator housing is connected to the associatable cover part by means of a peripheral weld, reliable sealing is obtained by way of the weld. Moreover the weld provides for a reliable connection between the free longitudinal edge and the associatable cover part so that in this respect failure is reliably prevented even when correspondingly high pressure peaks are initiated. On the whole the connection stability for the accumulator solution can be increased by way of the peripheral weld.

Both the placement of the cover part in the accumulator housing, and also the preparation of a clamping seat between the free longitudinal end of the accumulator housing and the cover part, as well as formation of the peripheral weld in the indicated region, can be easily and economically accomplished so that the described solution can be implemented as a disposable concept which is intended not to maintain cheap accumulator solutions as necessary, especially not to refill them on the gas side by means of the working gas, but to dispose of them in case of maintenance or failure and replace them by a new cheap accumulator.

In one preferred embodiment of the hydraulic accumulator as claimed in the invention, provision is made such that at least one of the two cover parts is provided on its one side with a conically running fixing bevel against which the free longitudinal edge of the accumulator housing is advanced. Preferably between the end of the free longitudinal edge of the accumulator housing and the fixing bevel of the cover part a preferably V-shaped fillet groove is formed which holds the weld. This fillet groove dictates a guide path for the peripheral weld to be formed; this facilitates the weld production process accordingly.

In another preferred embodiment provision can also be made such that the indicated V-shaped fillet groove is not provided with a welding filler, but for example with an electron beam welding process or other welding process suitable for this purpose the facing edges, especially of the free longitudinal edge of the accumulator housing in addition to adjacent parts of the cover part, are welded on, these welded-on material parts then being able to fill the fillet groove accordingly, and then generally projection of the weld beyond the fillet groove should not be expected. Depending on the materials used, it is also possible to weld on only the free longitudinal edge of the accumulator housing and to leave the material of the cover part essentially untouched.

In another especially preferred embodiment of the hydraulic accumulator as claimed in the invention, the respective cover part which seals the working chamber with the working gas in the accumulator housing calls for a through opening at least for introducing the working gas, which can be sealed gas-tight by a terminating device. This terminating device can consist of a plug which is to be driven into the through opening; this leads to an especially economical solution, or the terminating device is formed from a detachable sealing cover which allows refilling processes for the hydraulic accumulator, especially on its side with the working gas. Regardless of what was described above, it is of course also possible to set up hydraulic accumulators designed to be disposable at the site of their production or at central maintenance sites for re-use and to refit them if failed parts can be replaced by new ones.

Other advantageous embodiments of the hydraulic accumulator as claimed in the invention are the subject matter of the dependent claims.

The piston accumulator as claimed in the invention will be detailed below using two embodiments as shown in the drawings. The figures are schematic and not to scale.

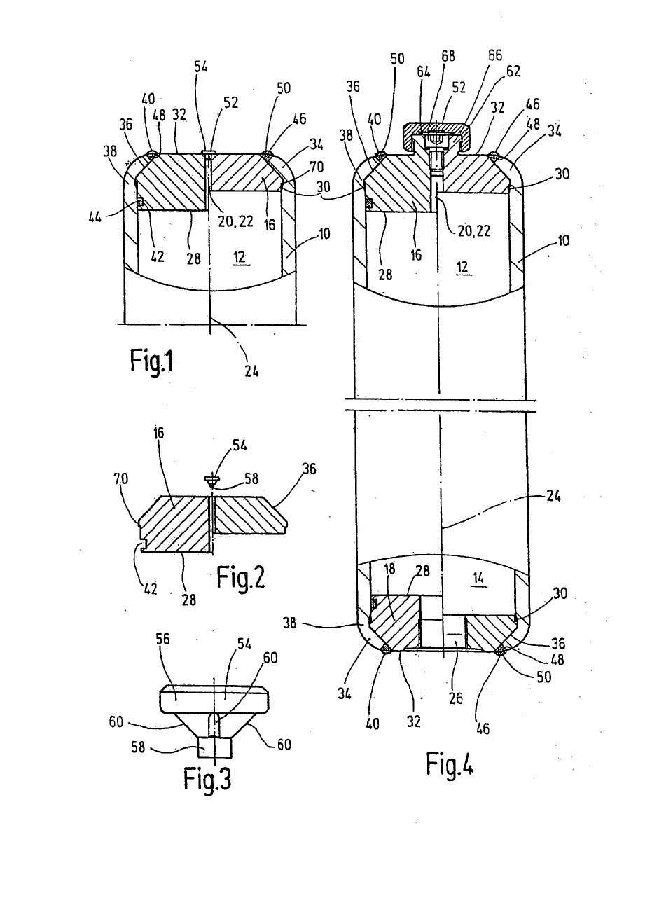

FIG. 1 shows partially in a longitudinal section the top part of a first embodiment of a piston accumulator,

FIG. 2 shows the cover part of the piston accumulator used in FIG. 1, with a plug to be inserted,

FIG. 3 shows enlarged the plug as shown in FIGS. 1 and 2, and

FIG. 4 shows partially in a longitudinal section the top and bottom part of a second embodiment of the piston accumulator as claimed in the invention with an altered cover part, in addition to the attached closing cover.

The piston accumulator shown in FIG. 1 as the accumulator housing 10 has an outer cylinder pipe in which as the separating element a piston which is not detailed with its sealing system on the outer peripheral side can be moved longitudinal. These piston accumulators with pistons as the separating element are known in a host of designs, and are described for example in the state of the art in DE 103 03 988 A1. The indicated piston which is not detailed within the accumulator housing 10 separates two working chambers 12, 14 (compare also FIG. 4) from one another, one working chamber 12 being used to hold the working gas, especially in the form of nitrogen, and the other, second working chamber 14 forming the so-called liquid chamber for the piston accumulator. Depending on the operating situation of the accumulator, the movement positions of the piston and moreover the volumetric portions of gas and fluid in the working chambers 12 and 14 vary.

On the front ends of the accumulator housing 10 there is one cover part 16, 18 each with a gas port 20 which in the form of a through opening 22 along the longitudinal axis 24 of the hydraulic accumulator penetrates the first cover part 16 which is the upper part viewed in the direction of looking at FIGS. 1 and 4, and with a liquid port 26 which likewise runs coaxially to the longitudinal axis 24 for connecting the piston accumulator to a total hydraulic system. This gas port 20 in the form of a through opening 22 is used in turn to fill the accumulator with the working gas, the embodiment as shown in FIG. 1 fundamentally relating to a piston accumulator solution which when the working gas is lost is generally not refilled and the embodiment as shown in FIG. 4 relating to an accumulator means which can be refilled with working gas.

To refit the respective hydraulic accumulator as shown in FIGS. 1 and 4, provision is made such that the respective cover part, here the cover parts 16 and 18, with their side 28 facing the inside are inserted into the accumulator housing against a stop 30 in the form of an offset, obliquely running annular surface within the accumulator housing 10. On the outer side 32 of the respective cover part 16, 18 conversely it is fixed via the free longitudinal edge 34 of the accumulator housing 10, for this purpose the longitudinal edge 34 undergoing a feed motion onto the respective cover part 16, 18; this will be detailed below and has already been described accordingly in DE 103 03 988 A1.

For feed of the respective longitudinal edge 34 of the accumulator housing 10 a shaping tool which is not detailed is used, said shaping tool being provided with a corresponding feed bevel which places the longitudinal edge 34 on the respective cover part 16, 18 such that it is fixed as a clamp seat in the accumulator housing 10 between the stop 30 and the associatable longitudinal edge 34. To prepare this clamp seat, one respective outer side 32 of the respective cover part 16, 18 is provided with a fixing bevel 36 which is tilted to the outside conically to the longitudinal axis 24 of the accumulator housing 10. The tilt of this fixing bevel 36 corresponds generally to the feed bevel of the forming tool; here however also other obvious tilts or bevels are also conceivable.

In order to achieved better deflection of the respective free longitudinal edge 34 around a type of articulation 38 it can be provided that this longitudinal edge 34 is reduced in wall thickness relative to the other wall parts of the accumulator housing 10, the transition site or articulation 38 between the different wall thicknesses forming the stop 30 for the respective cover part 16, 18. Furthermore, which is not shown, the longitudinal edge 34 on its side facing the respective cover part 16, 18 and oriented to the exterior can be provided with an insertion bevel which, running especially conically, facilities insertion of the respective cover part 16, 18 into the interior of the accumulator housing 10.

In order not to endanger the secure position of the respective cover part 16, 18 in the accumulator housing 10, and in order to prevent damaging application of forces, the end 40 of the respective free longitudinal edge 34 is guided such that it ends with its outermost exterior end essentially in one plane with the exterior 32 of the cover part 16, 18 which runs transversely to the longitudinal axis 24 of the hydraulic accumulator. The indicated forming processes for the respective free longitudinal edge 34 can however proceed cold, but also as a hot forming process. Conversely the material for the accumulator housing 10 can be one with correspondingly good workability, for example in the form of a conventional steel material.

In order to apply the respective clamping forces optimally to the associatable cover part 16, 18, and in order to ensure good support in the accumulator housing 10 also on the edge side for the cover parts 16, 18, provision is made such that the height of the respective cover part 16, 18 is matched to the conditions of use dictated by accumulator operation. Viewed in the direction of looking at FIGS. 1, 2, and 4, in one embodiment the height of the respective left half of the cover part 16, 18 is such that it is at least twice as great as the length of the longitudinal edge 34 between its free end 40 and the deflection site or articulation 38. But it is also possible, as shown in the respective right half of the figure, to reduce the height of the cover part 16, 18; this applies especially in the event in which there is no engagement groove 42 for engaging a peripheral sealing means in the form of at least one gasket 44. Such a version is possible when with respect to short service lives of the accumulator or with respect to low pressures the sealing means in the form of a gasket 44 located on the peripheral side in the respective cover part 16, 18 is not absolutely necessary. If for an embodiment, which is not detailed, the accumulator housing is however made correspondingly large in diameter, the height of the cover part 16, 18 can however be reduced accordingly relative to the length of the longitudinal edge 34.

But in all the above described solutions provision is made such that for gas-tight and/or fluid-tight sealing of at least one working chamber 12, 14 relative to the exterior, the associatable, advanced free longitudinal edge 34 of the accumulator housing 10 is connected to the associatable cover part 16, 18 by means of a peripheral weld 46. For positioning of the indicated weld 46 it is provided that between the end 40 of the free longitudinal edge 34 of the accumulator housing 10 and the fixing bevel 36 of the cover part 16, 18 a V-shaped fillet groove 58 is formed. The weld 46 fills the fillet groove 48 with a projection which viewed in cross section forms a convexly running top 50 which projects over the top 32 of the respective cover part 16, 18 and of the free end 40 of the longitudinal edge 34. The top 50 of the weld 46 in this way protects the respective end regions of the accumulator housing 10 and cover part 16, 19 and visually enables checking which ensures a complete hermetic seal for a cleanly configured weld 46 in the fillet groove 48. In another embodiment of the hydraulic accumulator as claimed in the invention, which embodiment is not detailed, the weld 46 need not protrude over the groove 48 with a projection, but can accordingly end flush vertically with the top 32 of the cover part or can even be set back to the inside toward the accumulator housing 10. A weld filling material can be placed in the V-shaped fillet groove 58; but it is also possible via a suitable welding process, such as an electron beam welding process, for example to melt-on the free end of the longitudinal edge 34 of the accumulator housing 10 and in this way to form the weld 46 via the melt addition of this material portion in the fillet groove 48. Depending on the material selection, the respective cover part 16, 18 with its material portions can also contribute to formation of the weld.

With respect to the high volatility of the working gas in the working chamber 12, this hermetic cover seal acquires special importance, relative to the gas side of the hydraulic accumulator. For the purpose of an economical solution as shown in FIG. 4, on both sides of the accumulator housing 10 the feed bevels over the longitudinal edge 34 are prepared at the same time by means of a shaping tool which is not detailed. Since an especially gas-tight configuration in the region of the working chamber 12 is important, it would also be conceivable on the fluid side of the accumulator with the working chamber 14 to choose a different cover solution. Besides the additional sealing via the gasket 44, it also allows simplified installation for the respective cover part 16, 18 since the gasket 44 due to its elastic expansion is able to keep the respective cover part on the inner periphery of the accumulator housing 10 in its installation position. In other configurations of the hydraulic accumulator it is possible to omit the sealing means in the form of a gasket 44 and to effect sealing solely by way of the weld 46. But the possibility also exists of having the gasket 44 perform the important sealing function and to regard the weld 46 as a holding means which also ensures at high pressures that the free longitudinal edge 36 is not lifted off the respective associatable cover part 16, 18.

The cover part 16 which seals the working chamber with the working gas in the accumulator housing 10, in any event, is provided with a through opening 22 which can be sealed essentially gas-tight by a terminating means 52. As shown in FIG. 4, on the opposing side of the accumulator housing 10 the through opening 22 into the associatable cover part 18 is a corresponding fluid passage site for connection of the accumulator to a conventional hydraulic system (not shown). In the embodiment as shown in FIG. 1, the terminating means 52 consists of a plug 54 as is shown enlarged in FIG. 3. The plug 54 consists preferably of a ductile material and in this way can be driven into the through opening 22 of the cover part 16 via a driving device which is not shown, as a result of the completed deformation the plug 54 remaining adherent in the passage opening 22, even if a corresponding high gas pressure is prevailing in the working chamber 12. But preferably provision is made such that the plug 54 be joined to the cover part 16 via a welding process, for example, a friction welding process. For this purpose, which is not detailed, nitrogen filling of the working chamber 12 by way of a detachable means is induced onto the top of the hydraulic accumulator and sealing with the latter, and then the indicated fixed connection is produced via a friction welding means within the detachable means.

As is to be seen in particular in FIG. 3, the plug 54 for this purpose has a stop head 56 which is larger in diameter than the cylindrical insertion part 58 projecting downward for engaging the through opening 22 provided for this purpose. Furthermore, between the stop head 56 and the insertion part 58 oriented to the latter there are conically tapering, bridge-like groove surfaces 60. The groove surface 60 which partially widens on the bridge is used on the one hand for improved insertion into the through opening 22 and otherwise the bridge-like surfaces ensure good adhesion to the respective interior wall of the through opening 22 so that unintentional disengagement, for example due to the gas pressure in the working chamber 12, is precluded. Preferably it is moreover possible to ensure gas feed into the working chamber 12 via the recessed groove surface 60 with the plug 54 seated on the cover part 16. Then in one step the hydraulic accumulator is filled with the active gas and the working chamber 12 is sealed via the plug 54 by means of the indicated friction welding process. With this sealing configuration by means of the plug 54 a reliable, cheap solution is achieved which allows the user to regard this hydraulic accumulator also as a disposable product, i.e., after one-time use to replace it by a new, comparable hydraulic accumulator and to accordingly dispose of the used one or return it to the manufacturer for recycling or to a maintenance shop.

The terminating means as shown in FIG. 4 differs conversely in that it has a sealing cover 62 which is provided with a sealing means 64 in the form of a flat ring seal. The latter is guided on the end side on the inside of the sealing cover 62 on a corresponding offset receiver. This sealing cover 62 can be screwed onto a connecting part 66 which is penetrated by the associated through opening 22 and which is located as a cylindrical extension projecting over the cover part 16 on the latter. Preferably provision is furthermore made such that for this configuration an engagement screw 68, preferably in the form of an Allen screw, is inserted into the through opening 22. In addition to a media-tight termination, for example via an additional sealing element between the screw head and the engagement thread of the engagement screw 68, the terminating means 52 which has been modified in this way by unscrewing the sealing cover 62 in addition to the engagement screw 68 allows a gas refilling process from the exterior in order to make the accumulator ready to operate again on site.

As FIG. 2 which relates to the respective cover part 16, 18 furthermore shows, between the engagement groove 42 for the sealing means 44 and the conically tapering fixing bevel 36 there is an annular contact shoulder 70 which projects in the manner of a step over the remaining cover part 16, 18 with a small protrusion and in this way facilitates the folding-over process for the respective longitudinal edge 34 of the accumulator housing 10 in the manner of a flanging process and the conical surface parts which run toward one another in the form of a fixing bevel 36 with the longitudinal edge 34 and in the form of an articulation 38 form a reliable clamping seat for the respective cover part 16, 18.

With the overall configuration in the region of the respective cover part 16, 18 including the end-side welds 46 and the sealing terminating means 52, a hydraulic accumulator solution which can be economically produced is devised which satisfies the highest requirements with respect to its tightness.

1. Hydraulic accumulator, in particular a piston accumulator, having an accumulator housing (10), and a separator piston which can be moved in the longitudinal direction in the accumulator housing (10) and which separates two working chambers (12, 14) from one another within the accumulator housing (10) which is closed on the end side by one cover part (16, 18) each, at least one cover part (16, 18) on its one side (32) being fixed by way of a free longitudinal edge (34) of the accumulator housing (10), which is advanced onto this cover part (16, 18) for this purpose, characterized in that for gas-tight and/or fluid-tight sealing of at least one working chamber (12, 14) relative to the exterior, the associatable, advanced free longitudinal edge (34) of the accumulator housing (10) is connected to the associatable cover part (16, 18) by means of a peripheral weld (46).

2. The hydraulic accumulator as claimed in claim 1, wherein at least one of the two cover parts (16, 18) is provided on its one side (32) with a conically running fixing bevel (36) against which the free longitudinal edge (34) of the accumulator housing (10) is advanced.

3. The hydraulic accumulator as claimed in claim 2, wherein between the end (40) of the free longitudinal edge (34) of the accumulator housing (10) and the fixing bevel (36) of the cover part (16, 18) a preferably V-shaped fillet groove (48) is formed which holds the weld (46).

4. The hydraulic accumulator as claimed in claim 3, wherein the weld (46) fills the fillet groove (48) with a projection which viewed in cross section forms a convexly running top (50) which projects over the top (32) of the cover part (16, 18) and of the free end (40) of the longitudinal edge (34).

5. The hydraulic accumulator as claimed in claim 1, wherein the respective cover part (16) which seals the working chamber (12) with the working gas in the accumulator housing (10) calls for a through opening (22) at least for introducing the working gas, which can be sealed gas-tight by a terminating means (52).

6. The hydraulic accumulator as claimed in claim 5, wherein the terminating means (52) consists of a plug (54) which consists of a ductile material and in this way can be driven into the through opening (22) of the cover part (16) and/or can be welded to it.

7. The hydraulic accumulator as claimed in claim 6, wherein the plug (54) has a stop head (56) which is larger in diameter than the insertion part (58) which projects downward for engaging the through opening (22) and wherein between the stop head (56) and the insertion part (58) and facing the latter there are conically tapering, bridge-like groove surfaces (60).

8. The hydraulic accumulator as claimed in claim 7, wherein the terminating means (52) consists of a sealing cover (62) which is provided with a sealing means (64) onto which a connecting part (66) which is penetrated by a through opening (22) can be screwed and which is located projecting over the cover part (16) on the latter when the accumulator housing (10) has a smaller diameter.

9. The hydraulic accumulator as claimed in claim 1, wherein at least one cover part (16, 18), with its side (28) opposite one side (32) is inserted against a stop (30) within the accumulator housing (10) into the latter and/or wherein the respective cover part (16, 18) is held by the clamping force of the advanced free longitudinal edge (34) in its end position.

10. The hydraulic accumulator as claimed in claim 1, wherein at least one cover part (16, 18) between its two sides (32, 28) on the outer peripheral side is provided with an engagement groove (42) for at least one gasket (44) and wherein between this engagement groove (42) and the fixing bevel (36) there is an annular contact shoulder (70) which projects in the manner of a step over the remaining cover part (16, 18) with a small protrusion.
